(19) United States
(12) Patent Application Publication
(10) Pub. No.: US 2013/0049596 A1
(43) Pub. Date: Feb. 28, 2013

(54) SYSTEM FOR OPERATING AN LED LIGHT SOURCE

(71) Applicants: Bernd Oehle, Rheda-Wiedenbrück (DE); Stephan Pieper, Lemgo (DE)

(72) Inventors: Bernd Oehle, Rheda-Wiedenbrück (DE); Stephan Pieper, Lemgo (DE)

(73) Assignee: Zumtobel Lighting GmbH, Lemgo (DE)

(21) Appl. No.: 13/580,460

(22) PCT Filed: Feb. 23, 2011
(86) PCT No.: PCT/EP2011/052649

§ 371 Date: Nov. 9, 2012

(30) Foreign Application Priority Data
Feb. 23, 2010 (DE) 20 2010 002 655.5

(51) Int. Cl. H05B 37/02

(52) U.S. Cl. 315/113; 315/297

(57) ABSTRACT

The invention relates to a system for operating an LED-based light source which system comprises an operating device that is designed to transform the input-side mains voltage to a supply voltage, and a control unit for the light source, which control unit is connected to the operating device and operates the LEDs using the supply voltage obtained from the operating device. The control unit is arranged in a module which is designed as a unit separate from the light source and which is connected thereto by means of a preferably flexible cable.

The present invention relates to an arrangement for operating an LED-based light source. The arrangement in accordance with the invention is to be employed in this connection in particular in a so-called downlight.

LED-based light, sources are also being employed increasingly in the lighting sector, since effective space-illumination can also be achieved with the aid of the luminous intensities, attainable in the meantime. In comparison with conventional light sources, such as gas-discharge lamps or incandescent bulbs, LEDs have certain advantages in this connection with regard to their operational reliability. On the other hand, LEDs usually require electronic activation in order to be able to utilize the mains voltage that is available in a suitable way. Furthermore, in the case of such light sources effective dissipation of the heat that occurs is required.

In the present case it is provided in particular that the LED light source is inserted in a down light This is a built-in ceiling luminaire arranged within a hollow space between the actual room ceiling and a ceiling construction at a distance therefrom. Often, the spatial conditions are so confined here that only little space is available to accommodate the downlight. Accordingly, the need exists to configure such luminaires in a compact manner.

The underlying object of the present invention is to make an arrangement available for operating an LED-based light source that meets the above-mentioned requirements.

This object is achieved by means of an arrangement for operating an LED-based light source that has the features of claim 1. Advantageous further developments of the invention constitute subject matter of the dependent claims.

In the case of the solution in accordance with the invention in the first instance an operating device is provided which is designed to convert a mains voltage, on the input side into a supply voltage. This supply voltage is then converted by the actual electronics unit of the light source or a corresponding control unit into an operating voltage with which the LEDs are operated. The solution in accordance with the invention now provides that this electronics unit or control unit is relocated. In particular, in is arranged within a separate module which is separate from the light source and is connected to the light source merely by way of a cable, which is preferably flexible.

In accordance with the present invention accordingly an arrangement for operating an LED-based light source is proposed which has an operating device, which is designed to convert a mains voltage on the input side into a supply voltage, and also a control unit for the light source, which is connected to the operating device and with the aid of the supply voltage obtained from the operating device operates the LEDs. The control unit is in this case arranged in a module which is formed separately from the light source and is connected to the light source by way of a—preferably flexible—cable.

The relocation in accordance with the invention of the control unit into a separate module entails a plurality of advantages. On the one hand, the actual luminaire unit can be kept compact, this facilitating the installation of the whole luminaire. Furthermore, the electronics unit for operating the LEDs is now arranged separately from the actual heat source so that overheating can be precluded. In this connection, it can be provided in particular that the light source is arranged at a heat sink, and the control-unit module is separate from the heat sink.

The operating unit and the control-unit module are preferably connected together by way of a detachable cable connection. It has proved to be particularly advantageous in this connection to use a so-called patch cable with a J45 connector. As a result, a simple connection between the operating device and the control-unit module is rendered possible, this additionally simplifying the assembly of the luminaire. In this case, it can be provided in particular that the cable connection has leads for the voltage supply as well as leads for the signal-transmission.

In accordance with a preferred embodiment of the invention, the control-unit module forms a so-called DALI device. This means that the module is able to receive and transmit signals or commands in accordance with the known DALI standard. In particular, the control-unit module can also be designed to convert dimming commands obtained from a central unit or a local control unit in order to influence the light source in terms of its brightness.

The operating device can also represent a DALI device for communicating, for example, malfunctions or the like to a central unit.

Inc operating device is preferably designed to convert the mains voltage into a direct voltage that is suitable for the operation of the LEDs. If the light source then has a plurality of LEDs of differing colours, it is preferably provided that the operating device converts the mains voltage for each of the colours into a direct voltage that is suitable in each case.

The invention shall be explained in greater detail in the following with the aid of the enclosed drawing, in which:

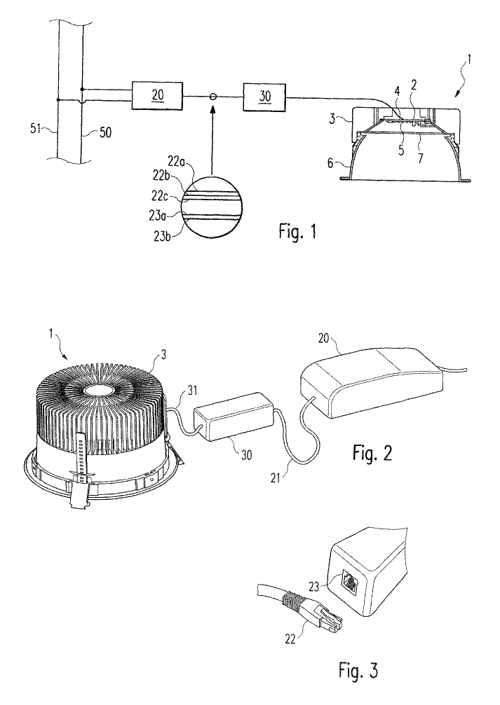

FIG. 1 shows an arrangement in accordance with the invention for operating an LED-based light source in a diagrammatic representation;

FIG. 2 shows a perspective view of a downlight in which the arrangement in accordance with the invention is employed; and

FIG. 3 shows a representation of the connection between the operating device and the control-unit module.

FIGS. 1 and 2 show, as an example for application of the present invention, a so-called downlight, although it is to be pointed out that the invention is not restricted to such types of luminaires. The relocation of the electronics unit into a separate control-unit module can also be employed in an expedient manner in the case of other types of luminaires, although the resultant advantaoes have an effect in the case of such built-in luminaires in particular. The downiight provided generally with the reference numeral 1 has in this connection—as can be inferred from FIG. 2—means on its underside for assembly in a suspended ceiling. Such assembly means for downlights are already sufficiently well known and accordingly shall not be explained in greater detail in the following.

An LED module 2 is employed as a light source in the present case, arranged in accordance with the diagrammatic representation of FIG. 1 in the depression of a heat sink 3. The LED module 2 consists of a printed circuit board 4 which is secured to the heat sink 3 and on which a plurality of individual LEDs 5 are arranged. These are radiated by way of a pot-shaped reflector 6 arranged in front of the heat sink 3, wherein means to even out the light-emission can be provided inside the reflector. In the exemplary embodiment shown this is a diffusing screen 7.

Since the normal mains-supply voltage of, for example, 220 volt is not suitable for operating the LEDs 5, the voltage made available by the current-supply network 50 is converted in a suitable way by means of two components. On the one hand, an operating device 20 is provided for this that is directly connected to the current-supply network 50 and whose task it is to convert the mains voltage on the input side into a supply voltage. In particular, conversion of the alternating voltage of the current-supply network 50 into a suitable direct voltage is effected. This voltage is converted in the usual way by a control unit 30, associated with the light source 2, into an operating voltage for the LEDs 5. In this connection, as a rule no further change is effected in the level of the direct voltage made available by the operating device 20. However, the direct voltage can be converted into a PWM-signal in order, by influencing the pulse width, to influence the intensity of the light emitted by the LEDs 5.

This electronics unit that is required to operate LEDs was previously arranged directly at the light source itself or directly in its vicinity in accordance with the invention it is now provided, however, that this electronics unit is relocated into a control-unit module 30 which is arranged away from the light source 2. In particular, the control-unit module 30 is even arranged separately from the heat sink 3 and is connected to the light source by way of a flexible cable 31. The connection between the operating device 20 and the control-unit module 30 is also effected by way of a cable 21, the configuration of which is explained further in greater detail below.

The relocation of the LED electronics unit into the control-unit module 30 entails the advantage in the first instance that the electronics unit is arranged away from the LEDs 5 and thus away from the heat source of the luminaire 1. The heat that occurs during the operation of the LED 5 is considerable and must be dissipated in an effective manner by way of the heat sink 3. On the one hand, it is now ensured by means of the arrangement in accordance with the invention that the heat cannot negatively affect the electronics unit. On the other hand, in comparison with a direct arrangement of the electronics unit at the light source 2 the heat can also be dissipated in a better way by way of the heat sink 3. A third advantage lies in the fact that—as explained further in greater detail in the following—the arrangement in accordance with the invention renders possible very simple assembly of the downlight 1. Finally, the relocation of the electronics unit also further entails the advantage that the downlight 1 with the heat sink and the reflector 6 can be configured in a very compact manner, this also render inc possible installation in very confined spaces.

Preferably, the possibility should also exist of being able to activate the downlight 1 by means of external control commands. In particular, it would be desirable to be able to carry out activation in accordance with the known so-called DALI standard.

Accordingly, in is provided that the operating device 20 is also additionally connected to the bus line 51 of a bus system, for example a DALI bus. The corresponding signal lines are then also continued in this case to the control-unit module 30 from the operating device 20, this preferably being effected within the connection cable 21. FIG. 1 shows, in this connection, a cutaway portion of the connection cable 21. This has in the first instance leads 22a, 22b and 22c for the transmission of the supply voltage. Furthermore, leads 23a and 23b are provided for the signal-transmission.

As regards the leads 22a to 22c for the transmission of the supply voltage it is to be noted that the number of leads used depends upon the configuration of the LED light source 2. The task of the operating device 20 is, as already mentioned, to convert the mains voltage into a suitable direct voltage for the operation of the LEDs 5. If now LEDs of differing colour are employed, these are usually operated at different voltages. For this, it is now provided that the operating device 20 makes available a suitable supply voltage for each of the various colours. In the exemplary embodiment shown, three different voltages are thus transmitted which can then be used to operate LEDs of three different colours, for example red, green and blue. If, on the other hand, merely LEDs of one single colour are to be used, the number of leads is also to be reduced.

If LEDs of different colours are employed, of course the brightness for each colour can be varied individually by means of the control-unit module 30. In this way, the possibility exists of emitting light of a suitable mixed colour.

The control-unit module 30 thus represents a DALI device which in a suitable way can convert the signals transmitted by way of the bus line 51. Furthermore, the possibility also exists of transmitting check-back signals to a central control unit in accordance with the DALI standard. In the same way, however, the operating device 20 can also be constructed as a DALI device. Here as well, transmission of operating information would be expedient in order to be able to report on malfunctions or the like, for example, to a control unit or central unit.

Of course, however, instead of the DALI standard another protocol could also be used for the signal-transmission.

Finally, the configuration of the connection cable between the control-unit module 30 and the operating device 20 shall be discussed. This is preferably a detachable cable connection, whereby the installation or the assembly of the downlight 1 is considerably simplified. For this, in the first instance the operating device 20 merely needs to be arranged in a suitable manner in the ceiling region and be connected to the corresponding leads of the current-supply network and also, if applicable, of the DALI bus. Since this can still be effected separately from the insertion of the downlight, such measures can be carried out simply.

Subsequently, merely the connection between the operating device 20 and the control-unit module 30 is established. The downlight can then be inserted into the ceiling and be fixed there with the aid of the assembly means.

The detachable connection between the operating device 20 and the control-unit module 30 is preferably achieved by using a so-called patch cable, with a J45 connector 22 being used for this that cooperates with a corresponding bushing 23 ac the control-unit module 30. As a result of the use of this patch cable, which contains the leads for the signal-transmission as well as the leads for the current-supply, it is possible to establish a connection between the two elements in a particularly simple, elegant and rapid manner. The use of alternative connectors would of course also be possible.

Furthermore, it would also be possible to configure the connection between the light source 2 and the control-unit module 30 so that it is detachable. Since, however, as a rule the action of the electronics unit is matched exactly to the LEDs, for which in particular calibration of the electronics unit is carried out during assembly at the factory, the possibility of separation of the light source from the electronics unit is less important. Accordingly, it is also possible to provide here—as shown—a fixed connection between the light source and the control-unit module.

All in all, the possibility is opened up by means of the present invention of using LED-light sources in downlights, for example, wherein the resultant luminaire can be kept extremely compact and at the same can be assembled in a simple and convenient manner.

1. An arrangement for operating an LED-based light source, said arrangement comprising;
an operating device, which is designed to convert a mains voltage on the input side into a supply voltage, and
a control unit for the light source, which is connected to the operating device and with the aid of the supply voltage obtained from the operating device operates the LEDs,
wherein the control unit is arranged in a module which is formed separately from the light source and is connected to the light source by way of a flexible cable.

2. The arrangement according to claim 1, wherein the light source is arranged at a heat sink, and the control-unit module is separate from the heat sink.

3. The arrangement according to claim 1, wherein the operating device and the control-unit module are connected together by way of a detachable cable connection.

4. The arrangement according to claim 3, wherein the cable connection has a J45 connector.

5. The arrangement according to claim 3, wherein the cable connection has leads for the voltage supply as well as leads for the signal-transmission.

6. The arrangement according to claim 1, wherein the control-unit module is a DALI device.

7. The arrangement according to claim 1, wherein the operating device is a DALI device.

8. The arrangement according claim 1, wherein the operating device is designed to convert the mains voltage into a direct voltage that is suitable for the operation of the LEDs.

9. The arrangement according to claim 8, wherein the light source has a plurality of LEDs of differing color, wherein the operating device is designed to convert the mains voltage for each of the colors into a direct voltage that is suitable in each case.
